(19) United States
(12) Patent Application Publication
(10) Pub. No.: US 2004/0220830 A1
(43) Pub. Date: Nov. 4, 2004

(54) Physician information system and software with automated data capture feature

(75) Inventors: Paul Y. Moreton, Plano, TX (US); David W. Moreton, Columbia, MO (US); David C. Breda, Plano, TX (US)

Correspondence Address: REED SMITH LLP, 2500 One Liberty Place, 1650 Market Street, Philadelphia, PA, 19103-7301, US

(73) Assignee: AdvancePCS Health, L.P.

(21) Appl. No.: 10/725,198

(22) Filed: Dec. 1, 2003

Related U.S. Application Data
(63) Continuation of application No. 09/416,564, filed on Oct. 12, 1999, now abandoned.

(51) Int. Cl. G06F 17/60

(52) U.S. Cl. 705/2; 455/556.2

(57) ABSTRACT

A system and method for collecting, storing, processing, and referencing information in a personal digital assistant system configured as an electronic physician assistant is provided. The system comprises a personal digital assistant having an electronic physician data module therein, a scanning device coupled to the electronic physician assistant, and an automated data collection module for electronically storing scanned data, the automated data collection module being associated with the electronic physician data module. The method scans a patient identification and associates the identified patient with a patient record. Furthermore, the method records medical data as an electronic file of information and assigns a readable code to the information. Then, when the code is accessed, the method associates the information with a patient record.

### CROSS REFERENCE TO RELATED APPLICATION

This patent application is a continuation is related to, and claims priority from, U.S. patent application Ser. No. 09/416,564, by Moreton, et al., entitled “PHYSICIAN INFORMATION SYSTEM AND SOFTWARE WITH AUTOMATED DATA CAPTURE FEATURE” filed on Oct. 12, 1999 which is incorporated herein by reference in its entirety.

### TECHNICAL FIELD

The invention relates generally to physician information systems, and more particularly, in a personal digital assistant system configured as an electronic physician assistant, a system, software program and method for collecting, storing, processing, or referencing information used by a physician with an automated data collection feature.

### BACKGROUND OF THE INVENTION

Physicians are bombarded daily with the need to access and provide vast quantities of information quickly and accurately. Physicians may receive pages, calls, faxes, email, or other requests for information in or outside of their offices. To cope with their information needs, physicians carry papers, index cards, reference books, and dictation devices, among other things, to collect and reference information—particularly when outside of the office. However, the use of cards, papers and other paper materials for referencing information is inefficient, often impracticable due to the weight or bulk of the materials, and may provide less than the most current information.

To assist physicians with these information needs, many hospitals provide information services for their physicians. For example, hospitals provide patient charts for collecting and referencing patient information. As another example, integrated health systems provide additional services, such as billing and collection systems, for their physicians. In addition, hospitals frequently provide dictation services whereby a physician will dictate a patient summary into a dictation device after a patient encounter and the hospital will then type the dictation and associate it with that patient's record. This service is typically used for encounters that occur while the patient is being treated or evaluated in the hospital. Services that are provided outside of the hospital must be documented, utilizing some other information management service.

Unfortunately, if a physician is not employed or directly managed by an integrated health system, then he is responsible for documenting his services, billing and collecting for his services, interfacing with multiple third party payers, scheduling patient encounters, providing medical services, and many other tasks. All of these responsibilities require the use of multiple information services. To cope with these tasks, many physicians are turning to physician information systems.

Modern physician information systems manage physician office information, and are often implemented as computer software programs. For example, some physician information systems provide information regarding drug interactions. Other physician information systems handle billing or insurance claims. Though representing a major stride forward for the physician and his staff, currently available physician information systems suffer from several drawbacks.

Unfortunately, since most residency training programs are part of integrated health systems. most physicians who enter private practice after completing residency training are poorly prepared for the responsibility of integrating the multiple information services that are required to perform all of the tasks required of them. This is just one disadvantage of prior art physician information systems.

Another disadvantage of prior art physician information systems is that they do not provide an integrated solution (this is due to the fact that typically physician information systems are vendor specific). For example, a drug company may provide a system which manages drug interactions. Likewise, an insurance provider could provide the insurance information system. Furthermore, a third party vendor may provide a program for managing diagnosis and treatment. In addition, the physician may use a completely separate calendar program for managing his schedule and patient interactions. These systems provide specific services but often they do not have any method of integration. This leaves the physician responsible for integrating information systems from various sources and programs, often relying only on his memory to accomplish the task of integration.

Another problem associated with physician information systems is that they typically run on an IBM compatible or Macintosh platform. This means that they must run on a computer (PC) at least the size of a laptop. For physicians seeing multiple patients in multiple locations, carrying even a laptop can be a cumbersome and tedious process. Accordingly, the physician is less likely to cant', and thus, less likely to have access to, the needed information. Furthermore, even when the physician information systems run on the same platform type, they are separate and must be accessed on an individual basis—in other words, they provide a nonintegrated solution.

Therefore, what is needed is a system, software program, and method for providing an integrated platform to the various modules of physician information systems. In addition, it is desirable for the platform to run on an easily portable device. Furthermore, it would be advantageous to have the ability to quickly record data, and then process and associate this with a patient. The present invention provides such a system, software program, and method.

### SUMMARY OF THE INVENTION

The present invention provides a physician or his staff with the ability to collect and access information quickly in or out of the office 5 through an integrated physician information system package. Furthermore, the present invention provides a system for automating the association of data identified by a scanned code with patient records.

In one embodiment the present invention provides a system for collecting, storing, processing, and referencing information. This system is implemented in a personal digital assistant system configured as an electronic physician assistant. The system comprises a personal digital assistant that has an electronic physician data module, and an automated data collection module that utilizes an information transmission device coupled to the personal digital assistant.

To provide communication capability to an outside communication channel, the system comes with a connectivity device, such as a wireless modem. The connectivity device provides access to a web page or email for updating a module. Furthermore, the system has an input/output port for transmitting and receiving information. Preferably, the information transmission device is a laser configured to read bar codes, but could also be an infra-red beam, an alpha-numeric scanner, magnetic strip reader, or a radio frequency transceiver.

An embodiment of the present invention configured as a software program operates in a personal digital assistant configured as an electronic physician assistant. The software program has an electronic physician data module, and an automated data collection module for electronically recording data (the automated data collection module is electronically associated with the electronic physician data module in software). The data is associated with a patient record or medical information.

In another aspect, the present invention is a method for associating a patient record with a patient identified by a patient identifier. The method stores a patient record in a PDA, reads a patient identifier with an information transmission device, and associates the patient identifier with a patient record. The method may also recall a patient list, or reference a module, such as the pharmacy module, rounds module, paging module, imaging module, or voice-to-text module. The method also provides for the association of medical information with a patient record. A medical identifier that can be accessed in a manner similar to the patient identifier identifies medical information, such as procedure and diagnostic codes. Typically, the medical identifier is a bar code. The patient record may then be transferred to another computing platform, such as a PC or another PDA.

The technical advantages of the present invention are numerous and include providing the physician and his staff access to integrated information, thus streamlining operations both in and out of the office. Furthermore, the present invention provides easy access to physician information, such as drug interactions, diagnosis, treatment, and patient information, easing the burden on the physician's memory. In addition, the present invention provides efficient means for capturing data, such as patient bar codes, procedure bar codes, diagnosis bar codes, and data entry options. These advantages are provided on a reliable, portable, and easy to use platform.

### BRIEF DESCRIPTION OF THE DRAWINGS

The above features of the present invention will be more clearly understood from consideration of the following detailed description taken in connection with accompanying drawings in which:

FIG. 1 illustrates one embodiment of the present invention implemented on a personal digital assistant;

FIG. 2 shows one configuration of the software for the present invention;

FIG. 3 is a flow diagram showing an algorithm for accessing and editing modules according to the present invention;

FIG. 4 shows a process flow diagram of an algorithm for editing information according to the present invention;

FIG. 5 is a detailed process flow diagram of one embodiment of an automated data collection algorithm, which may be implemented in software as an automated data collection module;

FIG. 6 illustrates one view of a screen displaying the automated data collection module; and

FIG. 7 displays the front page of the electronic physician assistant.

Corresponding numerals and symbols in the figures refer to corresponding parts in the detailed description unless otherwise indicated.

### DETAILED DESCRIPTION OF PREFERRED EMBODIMENTS

The present invention provides a physician or a physician assistant with the ability to collect, access, and manipulate information quickly in or out of the office through an integrated physician information system. Information may relate to patient profiles, physician rounds, prescription information, dictations, schedules, insurance, images, or any other information needed by a physician to run his or her (hereinafter, his) office. Furthermore, the present invention provides a system for automated data collection with other information types, such as patient information, in a physician information system. A personal digital assistant (PDA) provides access to the physician information system on a platform which is portable and upgradable.

PDAs are becoming popular platforms for many software systems. Like desktop personal computers (PCs), PDAs such as the Palm series (SPC1500, SPC1700), available from Symbol, Inc., provide icon-driven word processing and data processing capabilities on a handheld platform with a built in bar code reader. Furthermore, PDAs are inexpensive and widely available from computer vendors such as Comp USA, Best Buy, Radio Shack, and Office Max, just to name a few. Because the use of PDAs is proliferating, manufacturers are providing many peripheral devices and customized software systems to fully exploit the advantages offered by PDAs.

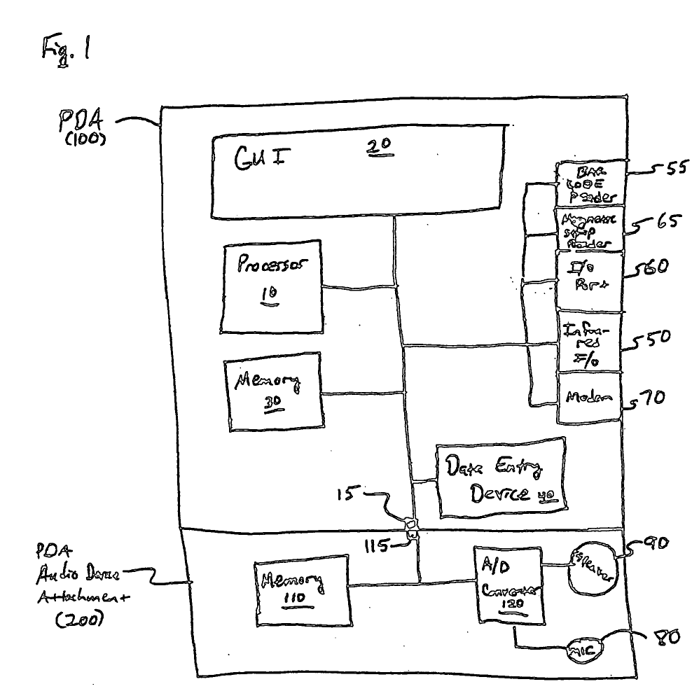

FIG. 1 illustrates one embodiment of the system of the present invention as implemented in a PDA 100. The PDA 100 comprises a graphical user interface (GUI) 20 flat panel display device, such as a liquid crystal display, a PDA compatible processor 10, such as the Dragonball, available from Motorola, memory 30, and a data entry device 40, which could be a keyboard, for example. Similar to a PC processor, the PDA processor 10, along with memory 30, functions as the “brain” of the PDA 100 by directing the operations of the PDA 100, including the processing of physician assistant software, input/output (I/O) functions, data entry, as well as the functioning of peripheral devices, for example. Memory 30 can be any type of PDA compatible memory, such as RAM or compact flash cards, and is used to store the physician assistant software. The data entry device 40, such as a keyboard, button, stylus, voice control, or other device, provides a user the ability to control the functions of the PDA 100, as well as the ability to enter data into the PDA 100.

To provide the PDA 100 the ability to communicate with other electronic devices, the PDA 100 has input/output (I/O) port. I/O ports, such as an infrared (I R) I/O port 50, bar code reader 55, an I/O port 60, a magnetic strip reader 65, or a modern 70, for example, provide the PDA access to outside devices and networks. The IR I/O port 50 provides IR communication and data transfers with devices such as keyboards, mouses, another PDA, or a PC. The bar code port 55 provides bar code reading capabilities for inputting data from bar code labels. Likewise, the I/O port 60 could be any I/O port, such as a parallel port for providing a 5 cable connection to a printer or a PC. The magnetic strip reader 65 provides the ability to read information from a magnetic strip, such as a strip found on a drivers license, health insurance card, or a credit card, for example. The modern 70 provides access to an Ethernet, the Internet, or any other modem-based device or network with a physical connection or wireless connection.

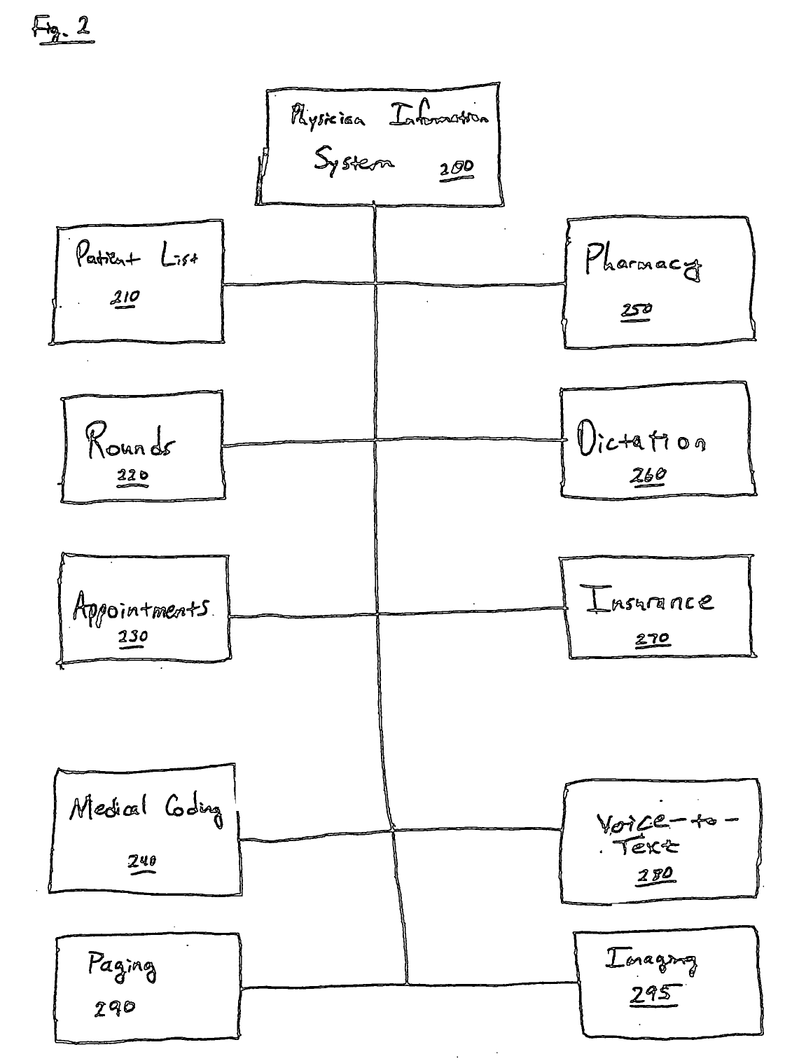

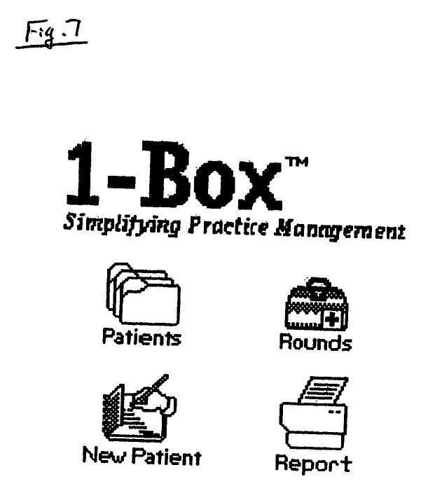

FIG. 2 shows one configuration of the electronic physician assistant software of the present invention. The electronic physician assistant software comprises a physician information system 200 for providing an integrated front page for a user, such as that shown in FIG. 6 (which is a copy of the screen display of a physician information system of the present invention). A patient list module 210 provides a database of a physician's patients, as well as access to general information regarding their demographics, insurance plan, health, allergies, etc. Using the patient list module 210, the physician or other user, in only a few seconds, may access and report a patients records, the patients allergies, preexisting conditions, etc. while in or remote to the office. This can be critical if for example, the patient is awaiting treatment for an injury sustained in a car accident.

A rounds module 220 provides the physician with information concerning his rounds for the day-including patient information, patient complaints, and the date of the last visit, for example. The rounds module 220, can be updated each day to incorporate the physician's appointments module 230 so that the patient records will appear in the order of the day's appointments. Furthermore, the appointments module 230 can manage the physician's time outside as well as inside the office so that the physician can have a “one-stop” personal time management tool that integrates personal and office management. The appointments module 230 can include reminders for physicians to search for and review information such as lab test, billing records, operating room schedules, and on-call schedules.

It is often challenging for physicians to recall the many codes used by hospitals, insurance companies, and other health care organizations. A medical coding module 240 provides a database of medical codes such as the Physicians' Current Procedural Terminology (CPT) and International Classification of Diseases (ICD) commonly used in hospitals that identify patient diagnosis, procedure, treatment management programs, and billing. Medical codes can also be scanned in using a quick list of bar codes representing CPT and ICD codes. Furthermore, it is practically impossible for anyone to rely on memory to track all possible drug uses, dosages and interactions. A pharmacy module 250 carries common prescription and over-the-counter drug information, such as treatments, preferred dosages, as well as information regarding interactions. Furthermore, the pharmacy module 250 provides the ability to prescribe drugs for a patient by printing a prescription or otherwise sending prescribing instructions to a pharmacy.

Physicians often receive telecommunication pages while in remote places. Numeric pages (pages where only a telephone number is left) require a physician to return the page without knowing the identity of the 5 number. This means that the physician can neither prioritize numeric pages or have needed information immediately at hand when the call is returned. Furthermore, the page often requires the physician to perform an activity once he reaches the office or hospital, and a numeric page does not provide the physician with information regarding these activities. A paging module 290 allows the physician to associate a page with the patient information by using caller identification (ID) functions. Thus, when a page is received by the physician assistant, an association is made by the paging module 290 between the calling number (using caller ID), or the telephone number left with a numeric page, with patient information. After the association is made, the physician assistant software can provide the physician with quick access to the record of the patient.

Insurance companies inundate physicians with piles of paperwork, regulations, and often conflicting procedures. An insurance module 270 provides the physician with information regarding the policies and procedures of insurance carriers and managed care providers so that the physician can make decisions in line with the guidelines of the policies he honors. This will provide the patient with more cost effective care since the patient will be able to make informed “on the spot” decisions about what procedures he has available and what portion of the expense he will be expected to bear for each procedure. A dictation module 260 gives the user the ability to record, store, manipulate, and edit his dictations using the PDA. The dictation module 260 also provides the ability to associate the dictation with a patient record.

A voice-to-text module 280 translates the voice file into a text file. This can be accomplished with proprietary software or commercially available programs such as Dragonspeak, of Simply Speaking, for example. An imaging module 295 allows the physician to associate a scanned image file, photograph file, or video image file to the patient file. Accordingly, it should be understood that an image can be photographed directly into the PDA 100 through a digital camera or the like which quickly attaches to the I/O port 60, and then, the image can be associated with a patient record with the imaging file 295. A scanner device may be attached in the same manner as the digital camera using the I/O port 60.

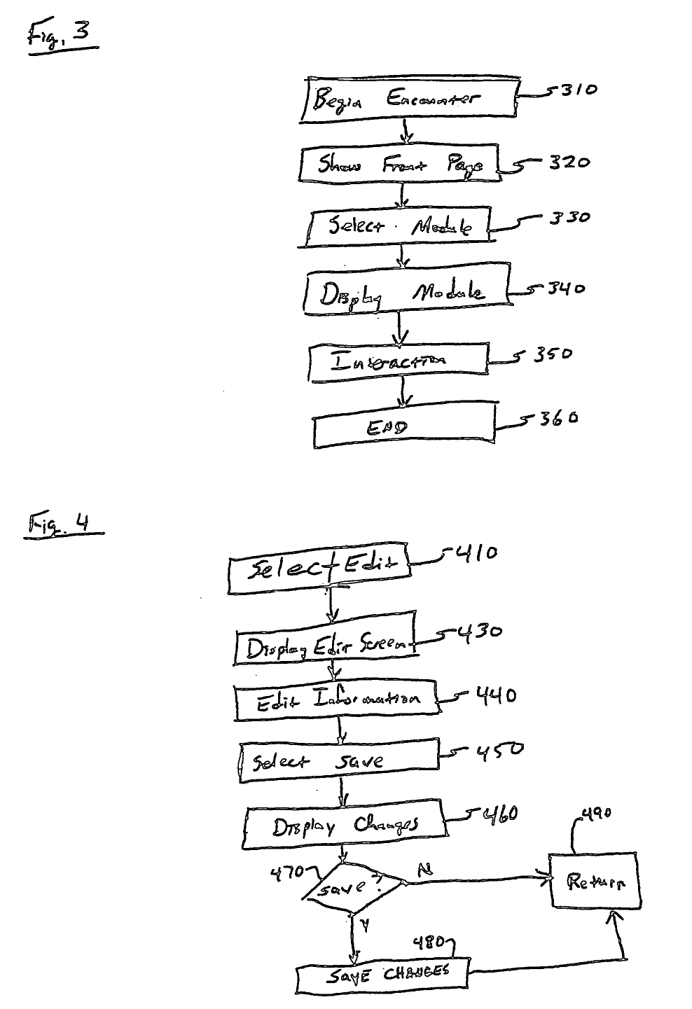

FIG. 3 is a flow diagram showing a method (or algorithm) for accessing and, when available, editing modules according to the teachings of the present invention. A begin encounter step 310 executes when the user activates the electronic physician assistant, which may be accomplished by clicking on an icon displayed on the PDA operating system screen display. The begin encounter step 310 comprises the process of loading the electronic physician assistant into memory. Next, in a show front page step 320, the PDA 100 displays the front page of the electronic physician assistant (illustrated as FIG. 7). In one embodiment, the front page provides the user, through the graphical user interface 20, icon access to each of the modules of the electronic physician assistant. The front page module, once displayed, will remain displayed until the user selects another module or exits the electronic physician assistant software. The user selects a module as he would any other icon displayed on a PDA, for example, by placing a cursor on the icon representing the chosen module, and then pressing a button on the PDA or a mouse, in a select module step 330. Likewise, the user may select to exit (turn-off) the electronic physician assistant by selecting the exit icon in an exit step 225. When the user executes the exit step 225, the PDA preferably returns to its operating system screen display.

Once a module has been selected, the selected module displays a module screen in a display module step 340. The physician will then read information from the PDA 100, and may also use an interactive module display to call up information, such as information contained in a database for example, in an interaction step 350. The user may also edit information in the interaction step 350, as discussed below. Eventually, the user will want to exit the module and does so in an exit step 360 by selecting the exit module icon. The exit step 360 comprises the processes of “closing out” the module, and returning to the show module options step 320.

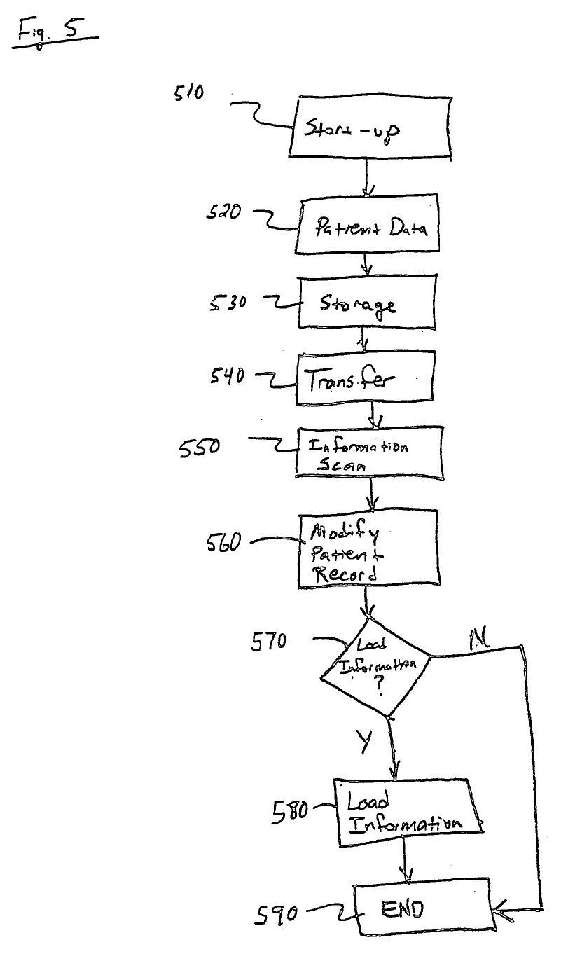

Sometimes, information may be edited as well as accessed from a module. FIG. 4 shows a flow diagram for implementing an edit function for the present invention. First, in a select edit step 41.0, the user of the electronic physician assistant selects the edit mode. The edit mode should be accessible from the front page screen of the electronic physician assistant or from selected modules, such as the patient list, rounds, or appointments modules, for example. Then, after the select edit step 410, the electronic physician assistant transitions into the edit mode and displays an edit screen in a display edit screen step 430. The edit screen may be standardized for the entire physician assistant program, or customized, depending on the module the edit mode is accessed from. Next, the user may edit or manipulate the information in an edit information step 440. Of course, any information may be serviced, such as patient records, treatments, or rounds information, for example. When the user has reached a point where he wishes to save the changes he has made (or to ignore the changes made), he should initiate the process of saving the changes in a select save step 450. However, before the changes are actually saved to memory, the electronic physician assistant will display the altered information in the appropriate format in a display changes step 460.

Next, the user is prompted to review the changes and see if he approves of them in a save query 470 If the user approves of the changes, he will select to save the changes and the changes to the information will be saved to memory in a save changes step 480. After the save changes step 480, the electronic physician assistant returns to the mode and screen which was displayed prior to the edit mode being implemented in a return step 490. For example, if the edit mode is initiated from the front page, then after the edits are saved the electronic physicians assistant returns to the front page. Likewise, if the edit mode is initiated from a module, then after the edits are saved the electronic physicians assistant returns to that module and its appropriate display. In the event the user chooses not to save the changes to the information in the save query 470, the algorithm immediately proceeds to the return step 490.

As discussed above, functionality is achieved in the electronic physician assistant through modular programming. The dictation module provides the physician, or another user, the ability to make an audio record and attach that audio record to a patient file. The audio record may be later downloaded to another computer, translated into text via a secretary or voice processing software, or maintained on the PDA for future use.

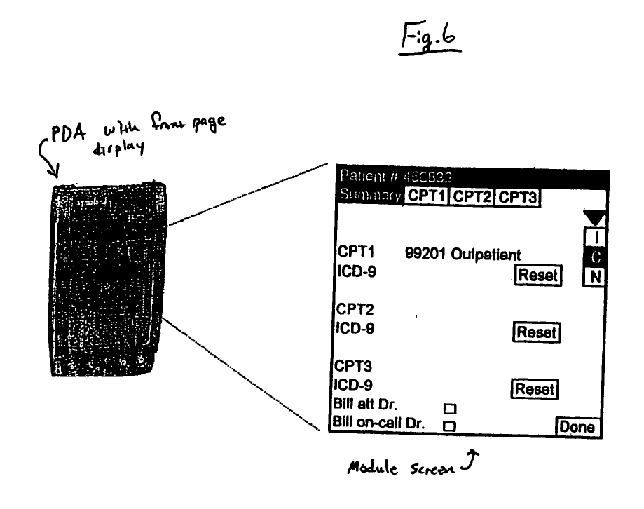

Further utility can be provided to a physician by enabling the electronic physician assistant to automatically gather, store, and associate information with patient information. FIG. 5 is a detailed process flow diagram of one embodiment of an automated data collection algorithm, which may be implemented in software as an automated data collection module 55. Although the following discussion is directed specifically to a bar-code-reading laser, the invention should not be interpreted to be so limited. For example, the electronic physician assistant and the automated data collection module 55 could be implemented to read information from a magnetic strip, an alpha-numeric scanner, infra-red beams, radio frequency transceiver, or any other data transmission device or system.

First, in a start-up step 510, the automated data collection module 55 is loaded into memory and an automated data collection module screen is displayed. FIG. 6 illustrates one possible configuration of the automated data collection module screen. The automated data collection module 55 provides the user with the ability to automatically gather, store, and associate information via a bar-code-reading laser. Each patient will be assigned a unique patient identifier, such as a bar code, magnetic strip identification, electronic code, or other patient identifier as needed by the selected data transmission device. Next, in one embodiment, the laser reads the bar code which is uniquely associated with the patent in a patient data step 520. Accordingly, the bar code itself may then be saved in any format, in a storage step 530. Next, in a transfer step 540, the automated data collection module 55 transfers the patient record for the patient uniquely associated with the bar code to the memory 30 of the PDA 100.

A physician can be provided with a number of bar codes associated with various diagnosis, medical codes, treatments, insurance information, or other information. Accordingly, the physician may scan in a medical code and relate it to the patient record in an information scan step 550. This information (the medical code in this case) is then associated with the patient record in a modify patient record step 560.

The patient record may be loaded into another computer, and makes the decision to do so in a load information query 570. If the user wishes to load the patient record in a computer, then the patient record is transferred by physical connection, wireless connection, or other means, in a load information step 580. Alternatively, the patient record may be stored to another hand held device for transferring at a later time in the load information step 580. If the user does not wish to transfer the data, the automated data collection module 55 terminates in an end step 590. Likewise, the automated data collection module 55 also terminates upon the completion of the load information step 580, in the end step 590.

In an alternative method, a PDA with a bar code reader is used to identify the patient by reading a bar code from an office chart or a hospital chart. The PDA then automatically notes the date and time of the patient identification. The PDA contains a list of patient records that have been previously downloaded from the office practice management database. However, new patient records can be created by associating a bar code with a record that can be downloaded into the PDA. The appropriate patient record is retrieved within the PDA.

The encounter is coded in the PDA using bar coding technology. Accordingly, a selection of bar codes of commonly used CPT and ICD codes is kept at the physician's workstation so that they may be scanned and associated with a patient record. Alternatively, the physician can use the pen based coding module that is contained in the PDA software to record codes for the encounter.

The requesting physician's name can similarly be associated with the patient record by bar coding the requesting physician's name from a list of physicians' names. Alternatively, the requesting physician's name could be entered into the PDA manually or from a list of previously entered requesting physicians' names which is stored on the PDA.

The information that is collected at the time of the encounter is transferred from the PDA to the receiving computer by radio transfer, hotsyncing, beaming, or other memory transfer device such as compact flash cards. Next, the resultant digital file (patient record and new information) is transferred to the billing office in the form of an email, internet, intranet, or transferred in another means of storage, such as a diskette, to the billing office. Accordingly, the transferred file would then be opened and reviewed for accuracy. Then, the file would be incorporated into the billing software program and collated with the additional information necessary to make a claim for payment from the appropriate insurance plan. Next, the transcription could be transferred, as an email or by other means, to a location with patient numbers so that the digital file can be electronically attached to the billing information. Furthermore, an electronic physician assistant could also do a random accuracy check on charts coming into the system.

While the invention has been described with reference to illustrative embodiments, this description is not intended to be construed in a limiting sense. Various modifications in combinations of the illustrative embodiments, as well as other embodiments of the invention, will be apparent to persons skilled in the art upon reference to the description.

1-21. (Cancelled)

22. A personal assistant system, comprising:
a personal assistant;
an electronic physician data module for collecting, storing, processing, and referencing information, the electronic physician data module being in said personal assistant;
an automated data collection module for inputting a patient identifier and relating said identifier with said information, the automated data collection module being in said personal assistant;
a sound recording device integral with said personal assistant; and
a dictation module for electronically storing recorded voice from said sound recording device as a voice file, the automated dictation module being adapted to associate said voice file with said information.

23. The system of claim 22, further comprising an information transmission device integral with said personal assistant.

24. The system of claim 23, wherein the information transmission device is a laser configured to read bar codes.

25. The system of claim 23, wherein the information transmission device is a magnetic strip reader.

26. The system of claim 23, wherein the information transmission device is an infrared beam.

27. The system of claim 23, wherein the information transmission device is an alpha-numeric scanner.

28. The system of claim 23, wherein the information transmission device is a radio frequency transceiver.

29. The system of claim 22, further comprising a connection to an external computer.

30. A method of automatically associating information with an individual identified by an identifier, said method comprising:
storing said information in a personal assistant;
recording a voice file associated with said information;
reading an identifier and relating said identifier with said voice file; and
automatically associating the identifier with the information.

31. The method of claim 30, wherein the step of reading scans a bar code uniquely associated with the individual.

32. The method of claim 30, further comprising the step of providing a physician with a second bar code associated with information.

33. The method of claim 32, further comprising the step of scanning the second bar code.

34. The method of claim 32, further comprising the step of associating the information associated with the second bar code with the information.

35. The method of claim 30, further comprising the step of transferring the information to a computer.

36. The method of claim 30, wherein the identifier is a bar code.

37. The method of claim 30, wherein the information transmission device is a laser configured to read bar codes.

38. A software program for operating a personal assistant system, comprising:
a personal assistant;
an electronic physician data module for collecting, storing, processing, and referencing information, the electronic physician data module being in said personal assistant;
an automated data collection module for inputting a patient identifier and relating said identifier with said information, the automated data collection module being in said personal assistant;
a sound recording device integral with said personal assistant; and
a dictation module for electronically storing recorded voice from said sound recording device as a voice file, the automated dictation module being adapted to associate said voice file with said information.

39. The software program of claim 38, wherein said automated data collection module accepts data gathered by an information transmission device.

40. The software program of claim 38, wherein the electronic physician data module associates a patient record with a patient.

41. The software program of claim 40, wherein said association occurs via data gathered by an information transmission device.
